(19) United States
(12) Patent Application Publication
(10) Pub. No.: US 2011/0185712 A1
(43) Pub. Date: Aug. 4, 2011

(54) Energy separation and recovery system for stationary applications

(75) Inventors: Michael Alan Burns, Seaford (GB); Paul Andrew Burns, Seaford (GB); Gareth Andrew Storoszko, Eastbourne (GB); Marco Cucinotta, Worthing (GB)

(73) Assignee: CLEANPOWER TECHNOLOGY, INC.

(21) Appl. No.: 12/658,197

(22) Filed: Feb. 4, 2010

(51) Int. Cl. F22B 1/18; F02G 5/02; F28F 1/10

(52) U.S. Cl. 60/320; 165/51; 165/182; 122/7 R

(57) ABSTRACT

An energy separation and recovery system wherein energy forms which might otherwise be wasted are employed in conjunction with a heat exchanger and a super heater to generate steam in a substantially closed-loop system wherein the heat supply is an open system. The superheated steam is transmitted to an engine to generate power which may be used to supply electrical energy. The electrical energy may be employed external to the system. Stepped diameter tubing carries water, or other vaporizable fluids, through the heat exchanger into the super heater while simultaneously exposing the carried water or fluid to incrementally higher temperature heated gas. Variable bellows, attached operatively to end plates accommodate the differential expansion of the tubing. The energy generation system includes a control module to permit the generation of steam and electricity at such times as there is sufficient heat to permit the generation of superheated steam.

The energy separation and recovery system may, alternatively, be employed to provide the power to an engine or other device or may provide an energy source to an alternative power consumption device which does not result in the generation of power.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright whatsoever in all forms currently known or otherwise developed.

### BACKGROUND OF THE INVENTION

This invention relates to energy separation and recovery systems and heat exchangers and more particularly to a novel compact, low back pressure heat exchanger which employs a novel exchanger/super heater configuration to generated superheated steam and a steam engine which operates in conjunction with the energy generator to provide a source of energy which is of sufficient magnitude to generate commercially viable quantities of power.

Over the years there have been numerous attempts to utilize the waste heat generated by the internal combustion engine to augment the power of the engine or supplement it by using the waste steam to run a steam turbine or other power plant. The inventions known in the prior art include utilizing the exhaust emitted by the internal combustion engine to heat water which will result in the creation of steam to run a steam turbine or other similar device to generate power which will augment or otherwise supplement that generated by the internal combustion engine.

Generally, the prior art discloses the use of waste heat from either or both of the primary sources of heat from the internal combustion engine, those being the hot exhaust gases that are vented from the engine by means of the exhaust pipe system and the heat vented by the engine block through the radiator system by means of the liquid cooled or air cooled systems generally employed in today's automobiles and trucks. Additional heat is vented by the block and moving parts of the engine, but inasmuch as that heat is not captured by either the radiation system or the exhaust system, it is effectively lost for purposes of motive power generation.

Heat can be recovered from a high temperature source and converted into work utilizing the well-known Rankine cycle. The heat is extracted from a high temperature heat source, for example a combustion exhaust gas stream, into a working fluid. The working fluid, which is initially liquid, is evaporated and the resulting pressurized working fluid vapor passes into an expansion turbine where work is generated to recover at least some of the heat energy extracted from the high temperature source. By using very high temperatures for the heat source and very low temperatures for the heat sink, high efficiency can be achieved for the heat recovery step.

The expansion turbine vapor exhaust, which is at a reduced temperature and pressure, passes to a condenser which is in thermal contact with a low temperature heat sink, typically a very large body of water or ambient air. The heat of condensation is rejected to the low temperature heat sink typically by cooling water, which is discharged into a large body of water or into the atmosphere by means of a cooling tower. Alternatively, air cooling is used with the heated air being discharged directly into the atmosphere. The ultimate heat sink remains at an essentially constant temperature relative to the thermal load rejected by condensation of the turbine exhaust. The heat thus rejected is not used for any beneficial purpose and cannot be utilized within the process which provides the source of the high temperature heat. It is therefore lost.

In U.S. application Ser. No. 12/214,835, there is disclosed accumulated energy system. Heat is employed in conjunction with a super heater/evaporator to generate steam, which is then stored in an energy accumulator which retains the stored energy by way of a heated water containment unit. The heated water containment unit accretes the energy and, upon attainment of a predetermined pressure and liquid level, steam is transmitted to a steam engine to generate power which may be used to run a generator and supply electricity. The heat may be from an internal combustion engine or other instrumentality which generates a sufficient quantity of heated exhaust gas to generate the requisite steam.

Separation and recovery may also be employed in connection with a hydrocarbon stream to vaporize it and thereby modify it. An example of such a system is described in United States Patent Application No. 2009/0324488 to Goodman, Wayne. The system includes a heat exchanger configured to transfer heat from the exhaust stream to a hydrocarbon stream. The heat exchanger may be a separate device from the catalyst element, or the heat exchanger and the catalyst element may be the same device. The heat exchanger described may be configured to allow heat exchange with the exhaust stream during some periods of operation and to block heat exchange with the exhaust stream during other periods of operation and may include a control to permit a fraction of the exhaust stream flowing to the heat exchanger, allowing a controllable fraction of heat from the exhaust stream to exchange with the hydrocarbon stream and/or catalyst element.

Systems are also known and described for accumulating steam by using the waste heat generated by a power plant and then using the steam to power a turbine or other power generation device. An example of such a system is described in U.S. Letters Pat. No. 4,555,905 and the patents and literature set forth therein.

A further example of such a system is described in U.S. Patent Application No. 2009/0301078 to Chillar, Rahul for a system that recaptures the waste heat discharge by power plant auxiliary systems. The system is used for increasing the efficiency of a power plant, wherein the power plant comprises at least one gas turbine and a heat recovery steam generator (HRSG), the system comprising: at least one auxiliary system; wherein the auxiliary system is in fluid communication with at least one component of the power plant and removes waste heat received from the at least one component of the power plant. A condenser is integrated with the HRSG, wherein the condenser receives condensate from the HRSG and comprises a condensate loop. The condensate loop transfers a portion of the condensate to an inlet portion of the auxiliary system and a heat recovery loop utilizes the condensate to transfer waste heat from the auxiliary system to the HRSG. The heat recovery loop increases the temperature of the condensate prior to returning to the HRSG which reduces the work performed by the HRSG and increases the efficiency of the power plant. Such systems may increase the efficiency of the power plant, but do not provide for an open, superheated steam system.

Today, in many areas of the world, pollution and related environmental concerns, has resulted in the implementation of severe pollution controls on waste disposal. It has also been determined that landfills and other degradable biomasses generate methane and other gases which modify the environment and add to global warming and other deleterious effects on the atmosphere. One initial solution is to capture the methane and other gaseous wastes and employ them, to the extent possible, to generate power. However, that often has the corollary effect of generating heat and other waste gasses.

By way of example, United States Application No. 2009/0173688 to Phillips, Roger describes the use of waste heat for sludge treatment and energy generation. In recent years the disposal of sludge in landfill and/or agricultural applications has proven ecologically sensitive. While short term disposal can have a positive effect on crop production, heavy metals and other contaminants in the material make long term disposal problematic, not to mention aesthetically disagreeable in certain areas. Additionally, state and local authorities are enforcing stricter regulatory standards and mandating better management practices for safe sludge disposal and use, making sludge disposal even more difficult for these facilities. These issues will become more and more critical in light of the fact that many facilities have reached their capacity to process effluent from an expanding industry and customer base.

Waste heat can be produced by a number of different sources, including, without limitation, power generation (coal-fired, natural gas fired, nuclear, etc.), wood product processing (pulp & lumber mills) and various other heat-producing processes including without limitation, waste heat produced from a biofuel, a reciprocating engine, a gas generator set, a gas turbine set, landfill, a by-product of landfill degradation and combinations thereof. An apparatus can consist of heat exchangers installed in the heat stream from the heat source, where heat can be captured prior to other forms of disposal. The apparatus can include all necessary valves, ducts, fans, pumps, and piping to redirect the heated material. It can control the delivery of waste heat to downstream drying and/or thermal processing stages using, in one embodiment, an automated control system.

Besides the internal combustion engine, there are numerous other sources of exhaust heat which may be employed to accumulate energy and generate power. One such source is the exhaust heat generated by the burning of methane gas at land fills and other similar locations.

The present technology for solid wastes is to deposit trash into landfills that may be covered over with soil and green plants when full. The separation of waste water (sewage) solid components will be sent to the landfills and the liquid components piped into bodies of water (ocean, lakes, and rivers). Trash may also be burned and sometimes converted to electricity. In rural areas, sewage waste has been used as soil complement or used in methane producing systems (mostly animal waste) usually used directly for home use (usually in 3rd world countries) or used as a source on large farms.

The major problem of landfills may be the lack of land, especially in urban settings. The sad stories of trash from East Coast (USA) and from Taiwan cities loaded on barges in search of dump sites, emphasize the enormity of the problem. The offensive odors generated and the proliferation of vermin, birds, dogs, and other organisms attracted to trash sites are undesirable. The production of methane, CO.sub.2 and other gases is a serious source of environmental pollution. The large area covered by the landfills precludes the capping of the landfill to harvest the methane and other gases for productive uses. Thus, methane is usually directed for harvest via tubing and other capping and delivery methods.

By way of example, U.S. Pat. No. 5,288,170 to Cummings; James B. describes a system for disposing waste in the landfill and means for disposing sludge in the landfill with the waste. The system is also comprised of means for collecting gas produced within the landfill resulting from the sludge mixed with the waste and means for generating electrical energy from the collected gas. The generating means is in fluidic communication with the collecting means. Preferably, the generating means includes an electrical generator which burns the gas to produce electricity. Preferably, the means for disposing the waste in the landfill includes at least one truck and/or at least one railroad car. Preferably, the means for disposing sludge in the landfill includes at least one sealable or covered container which can also be transported by truck or train.

In a preferred embodiment, the gas collecting means includes a plurality of gas extraction wells located throughout the landfill, a piping network connected to the extraction wells, pumping means for moving gas produced within the landfill into the piping network and containment means in communication with the piping network for storing collected gas.

### SUMMARY OF THE INVENTION

To overcome one or more of the drawbacks in the current energy technology and methods of employing waste heat exhaust gases, the current invention employs a dual core system comprised of a super heater and a heat exchanger. A finned tube array is disposed in connection with the heat exchanger to heat water and generate steam. A continuous tubing matrix directs a flow of fluid in a direct transverse to the direction of the waste heat and toward incrementally higher temperature of the waste heat. Waste heat exhaust gases are first passed over the tubing array of the super heater to superheat the steam within the super heater core. The waste heat exhaust gases are then passed over the heat exchanger segment of the unit to heat the water within the heat exchanger. The tubing array from the heat exchanger to the super heater is incrementally stepped up in diameter to achieve the open core flow and provide the superheated steam output. The superheated steam is transmitted to a steam engine to generate power which may be used to run a generator and supply electricity. The engine includes a control system to permit the generation of steam and electricity at such times as there is sufficient heat to permit the generation of superheated steam.

The energy separation and recovery system may, alternatively, be employed to provide the power to a power grid in order to provide electrical energy and thereby obtain a credit or funds for the insertion of such electrical energy into the grid for which a system user may receive compensation or credit. The energy separation and recovery system may also be employed to drive an engine or other device or may provide an energy source to an alternative power consumption device.

The energy separation and recovery system may, alternatively, be employed to provide the power to one or more energy consumption portions of the overall energy generation system. By way of example only, a portion of the power may be used within the electrical system of the heat exchanger itself in order to keep it operational during periods of time where startup is required via supplemental battery power.

The energy separation and recovery system may, alternatively, be employed to provide the power to additional energy consumption items within or without the facility, such as providing electricity to local homes.

### BRIEF DESCRIPTION OF THE SEVERAL DRAWINGS

The foregoing summary, as well as the following detailed description of preferred embodiments of the invention, will be better understood when read in conjunction with the appended drawings. For purposes of illustrating the invention, there is shown in the drawings embodiments which are presently preferred. It should be understood, however, that the invention is not limited to the precise arrangements and instrumentalities shown. In the drawings:

FIG. 1 illustrates a block flow diagram for an exemplary system for separating, recovering, and storing or transferring the electricity generated by the use of the waste heat exhaust gases into an electric grid or network, in accordance with one embodiment of the present invention.

FIG. 1A is a detailed exemplary and diagrammatic view of a waste energy separation and recovery system, in accordance with one embodiment of the present invention.

FIG. 2A is a side view of an exemplary view of a heat exchanger/super heater system for the separation and recovery of waste heat energy, in accordance with one embodiment of the present invention.

FIG. 2B is a side view of an exemplary view of a heat exchanger/super heater system for the separation and recovery of waste heat energy, in accordance with another embodiment of the present invention.

FIG. 2C is a side view of an exemplary view of a heat exchanger/super heater system for the separation and recovery of waste heat energy, in accordance with an embodiment of the present invention wherein the system also serves as a muffler.

FIG. 3 is a detailed side view of an exemplary view of a heat exchanger/super heater system for the separation and recovery of the waste heat energy, in accordance with one embodiment of the present invention.

FIG. 4 is a detailed view of an exemplary arrangement of the continuous tubing employed in connection with the heat exchanger and super heater configuration, in accordance with one embodiment of the present invention.

FIG. 5 is a detailed interior top view of a vortex fin assembly of the heat exchanger, before vacuum brazing, in accordance with one embodiment of the present invention.

FIG. 6 is a detailed sectional view of tube and vortex fin interface, after vacuum brazing, in accordance with one embodiment of the present invention.

FIG. 7 is a plan view of a single illustrative vortex fin plate structure for disposition within the heat exchanger, in accordance with one embodiment of the present invention.

FIG. 7A is a detailed interior view of a segment of a vortex fin plate of the heat exchanger, in accordance with one embodiment of the present invention.

FIG. 8 is an illustrative view of the gas flow pattern around a tube within the heat exchanger configuration, in accordance with one embodiment of the present invention.

FIG. 9 is an interior view of two corresponding heads for linking adjacent piping structures of the heat exchanger and super heater to form the continuous path in accordance with one embodiment of the present invention.

FIG. 10 is a detailed sectional view of the heat exchanger and super heater structure illustrating the adjacent hole structures through which the heat exchanger and super heater piping is disposed, in accordance with one embodiment of the present invention.

FIG. 11 is a diagrammatic representation illustrating the introduction of exhaust heat through the decrement staged piping of the system and the water input and superheated steam output for a single illustrative segment in accordance with one embodiment of the present invention.

FIG. 12 is a cross-sectional view illustrating the super heater structure and the head and end plate assemblies for linking adjacent segments of piping in accordance with one embodiment of the present invention.

FIG. 13 is a detail view taken of a corner of FIG. 12 illustrating the expandable section between the main core casing structure and the head and end plate assemblies for linking adjacent segments of piping in accordance with one embodiment of the present invention.

FIG. 14 is an illustrative view of an expandable bellows segment operatively associated with the head and end plate assemblies depicting the differential expansion as the result of the introduction of waste heat into the system in accordance with one embodiment of the present invention.

FIG. 15 is an illustrative view of the head to end plate interface showing the interlocking head with expanded tube detail in accordance with one embodiment of the present invention

FIG. 16 is an exploded illustrative view of the head to end plate interface showing the illustrative gaskets depicted thereon in accordance with one embodiment of the present invention.

FIG. 17 is an illustrative view of the assembled heat exchanger, fin assembly and superheater cores in association with the expandable bellows segment operatively disposed with the head and end plate assemblies and illustrative gaskets depicted thereon in accordance with one embodiment of the present invention.

FIG. 18 is an illustrative view of an assembled multi-core heat exchanger and super heater assembly in accordance with one embodiment of the present invention.

FIG. 19 is an illustrative view of an assembled multi-core heat exchanger and super heater assembly having vertically stacked tubing to provide multiple heat exchangers and super heaters to provide steam to multiple engines or other applications in accordance with one embodiment of the invention.

### DETAILED DESCRIPTION OF THE INVENTION

Certain terminology may be used in the following description for convenience only and is not limiting. The words “lower” and “upper” and “top” and “bottom” designate directions only and are used in conjunction with such drawings as may be included to fully describe the invention. The terminology includes the above words specifically mentioned, derivatives thereof and words of similar import.

Where a term is provided in the singular, the inventors also contemplate aspects of the invention described by the plural of that term. As used in this specification, the singular forms “a”, “an”, and “the” include plural references unless the context clearly dictates otherwise, e.g. “a waste heat source”. Thus, for example, a reference to “a method” includes one or more methods, and/or steps of the type described therein and/or which will become apparent to those persons skilled in the art upon reading this disclosure.

Unless defined otherwise, all technical and scientific terms used herein have the same meaning or meanings as commonly understood by one of ordinary skill in the art to which this invention belongs. Although any methods and materials similar or equivalent to those described herein can be used in the practice or testing of the present invention, the preferred methods, constructs and materials are described herein. All publications mentioned herein, whether in the text or by way of numerical designation, are incorporated herein by reference in their entirety. Where there are discrepancies in terms and definitions used by reference, the terms used in this application shall have the definitions given herein.

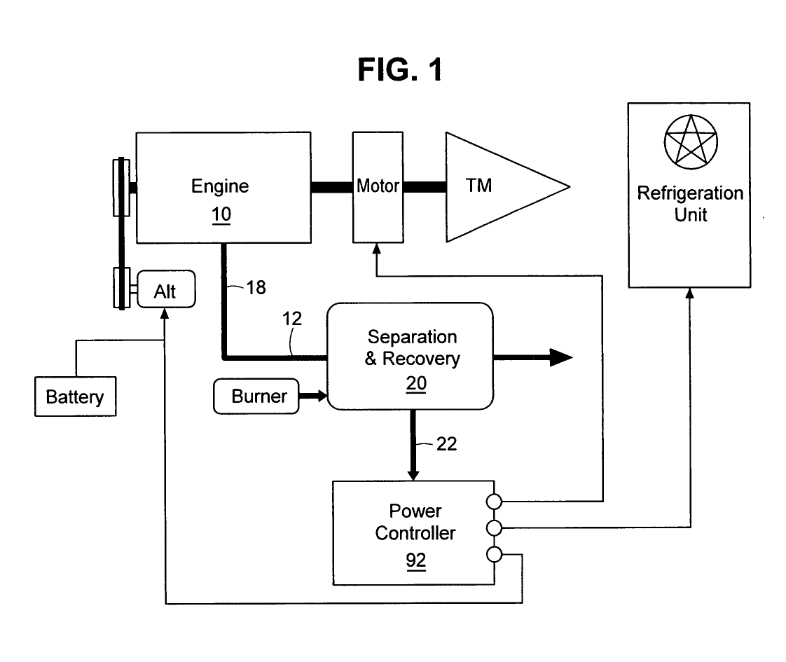

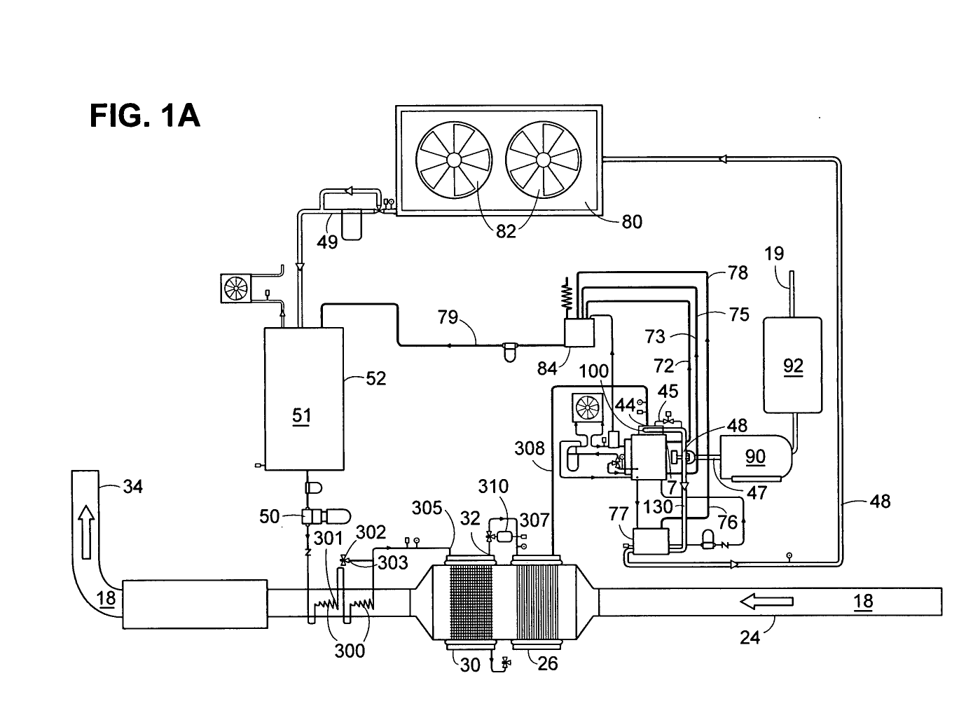

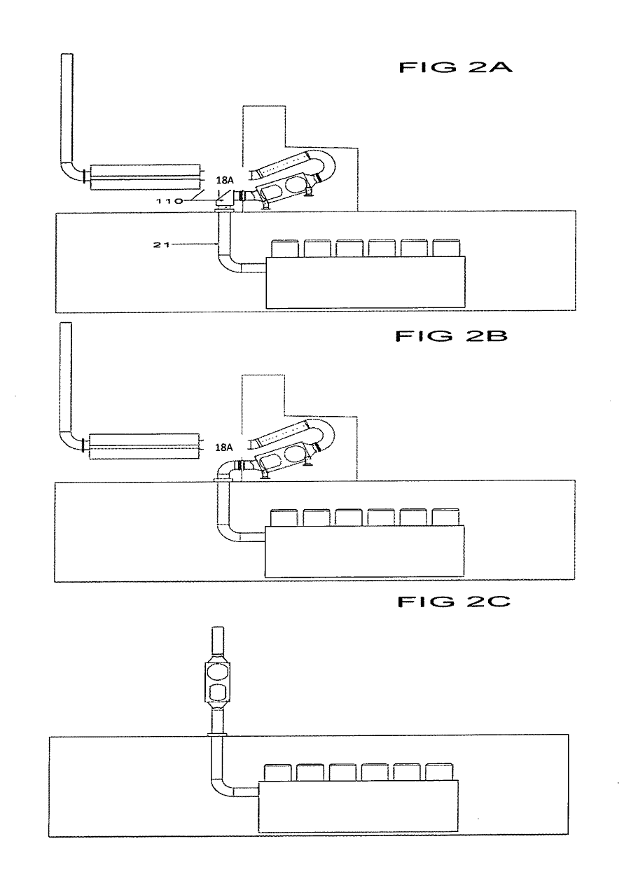

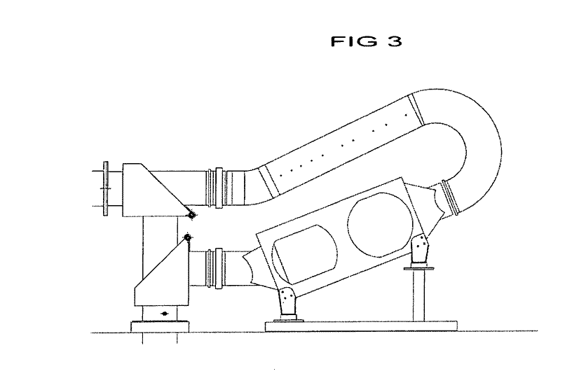

Referring to FIG. 1, FIG. 1A and FIG. 2A, in a preferred embodiment of the invention, the energy separation and recovery system 20 is located proximate to an energy source 10 which is generating gas or other combustible material. Gas 12 is transferred from the energy source 10 and is piped into a gas powered generator system 14 provided for generating electricity. A by-product of the generation of electricity is the thermal conversion of the gas 12 into essentially complete products of combustion. The gas powered generator system 14 serves simultaneously to produce electrical energy 16 and waste heat exhaust gases 18. The electrical energy 16 may be directly transmitted to a energy supplier such as the national grid 19. Alternatively it may actually be used to provide electricity to operate equipment at the energy source 10 site. The waste heat exhaust gases 18 are passed through a combustion exhaust duct system 21 and is utilized by the separation and recovery system 20 to generate additional electrical power 22 which may similarly be transmitted to an energy supplier or used to operate equipment at the site or elsewhere.

The separation and recovery system 20 and the electrical power generating systems may be positioned within a single structure. The structure may also house a steam engine drivingly connected to an electrical generator, and a condenser and a condensate recovery system all of which will be further delineated and exemplified in an embodiment of the invention. The structure can also house suitable condensate feed water systems to flow feed water in a loop through the separation and recovery system 20.

In the exemplary embodiment of the invention, hot waste exhaust gases 18 are flowed through the intake super heater side of the separation and recovery system 20 thereby reduce the temperatures of the waste heat exhaust gases 18 from approximately 1000° F. (620° C.) to approximately 600° F. (350° C.). The 600° F. waste heat exhaust gas 18 is continually flowed through the heat exchange elements of the separation and recovery system 20. Upon exiting the heat exchanger 30 the balance of the now cooled waste heat exhaust gas 18 is appropriately vented.

It is to be understood that the temperatures set forth above are merely illustrative and may be altered to optimize the particular separation and recovery system or the use to which the superheated steam is ultimately put.

Referring to FIG. 1A and FIG. 4, the waste heat exhaust gases 18 from the generator system 14 are directed via an exhaust piping system 24 to the super heater 26. A portion of the waste heat exhaust gases 18 may be diverted from the system if the temperatures are in excess of that which is required to provide superheated steam. A leading tube section 25 of the super heater 26 is that area proximate to the super heater steam outflow 40, as is best seen in FIG. 4.

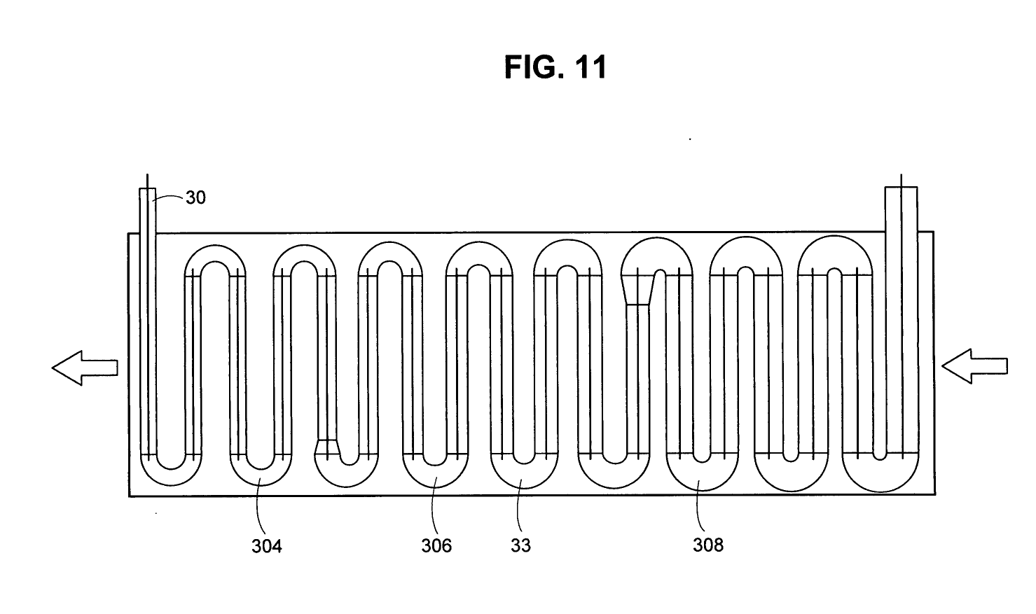

The waste heat exhaust gases 18 are sequentially passed from the leading tube section 25 of the super heater 26 through to trailing tube section 27 of super heater 26 and traverse sequentially a leading tube section 29 and a trailing tube section 31 portion of the heat exchanger 30. As is best illustrated in FIG. 11, the heat exchanger 30 is comprised of decreasing diameter tubing 33 such that, in the illustrated embodiment, approximately one half of the heat exchanger 30 nearest the leading tube section 25 is comprised of one diameter tubing and the second portion of the heat exchanger 30 nearest the trailing tube section 31 is comprised of a smaller diameter tubing.

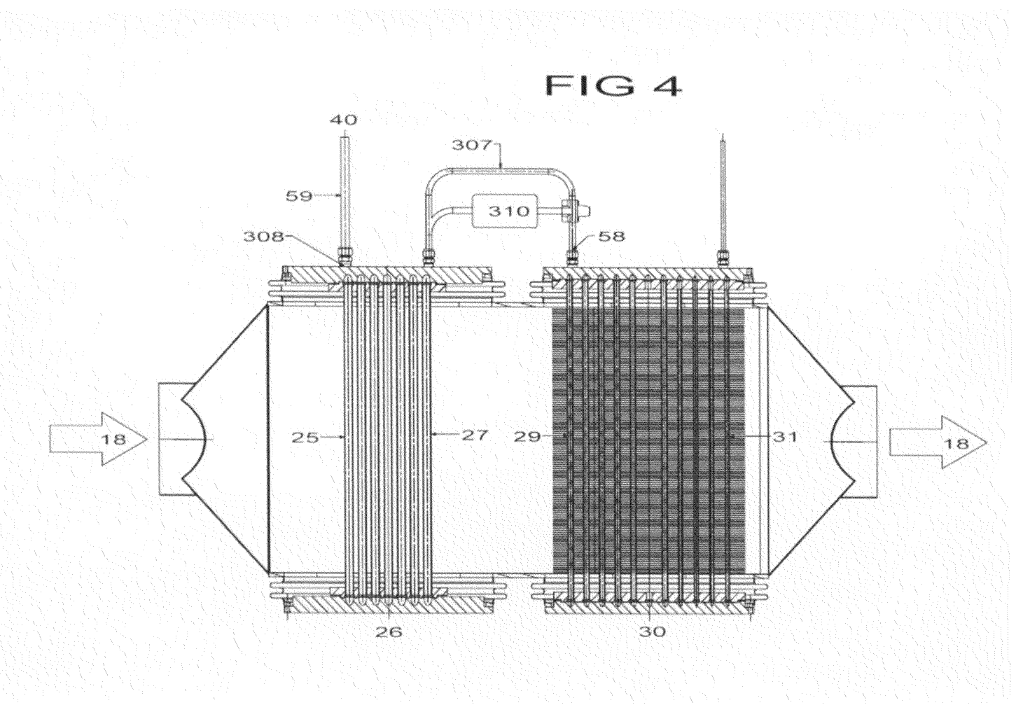

Continuing to refer to FIG. 1A and FIGS. 2 and 3, the waste heat exhaust gases 18 from which the energy has been separated are vented to the atmosphere by exhaust duct 34. Although the following description will refer to water as the fluid being employed, it is understood by those skilled in the art that other fluids may be employed to achieve similar results. Accordingly, as is illustrated in FIG. 1A, a water pump 50 takes water 51 from water tank 52 and causes it to flow through an initial series of one or more pre-heater sections 300, consisting of tubing 301 having a diameter which is substantially similar to the diameter of the trailing tube section 31 of the heat exchanger 30. The pre-heater sections 300 may be employed to heat the water or other fluid to a predetermined initial temperature which is, ideally, just below the boiling point of the fluid medium used. As can be seen from FIG. 1A, the pre-heater sections 300 may have a control valve system 302 to permit selective activation or deactivation of one or more of the sections 300. This permit the predetermined temperature to be accurately maintained based upon the initial temperature of the fluid.

In the event that less than all of the pre-heater sections 300 are employed, a by-pass tubing section 303 is interposed to permit the fluid to be introduce into the trailing tube section 31 of the heat exchanger 30 at input port 305. As is best seen in FIG. 1A and FIG. 10, the water 51 travels through a first series of tubes 304, which are the smallest diameter tubes employed in the system. In one embodiment of the heat exchanger 30, a number of spaced ⅜″ stainless steel tubes 304 are longitudinally disposed in an array which is transverse to the direction of flow of the gas 18. The array is designed to simultaneously maximize the tube area which is exposed to the flow of gas, while at the same time the array is arranged to minimize the effect which it has on back-pressure of the gas 18. The array may vary according to the specific embodiment and application for the energy separation and recovery system. This first series of tubes 304 are positioned such that the longitudinal axis of each tube is substantially perpendicular to the gas 18 flow.

Continuing to refer to FIGS. 1A and 10, the water 51 travels through the first series of tubes 304 into a second series of tubes 306 which are of a larger diameter then the first series of tubes 304. The first and second series of tubes form the heat exchanger 30 core. The gases 18 encounter the second series of tubes 306 at a higher temperature than they encounter the first series of tubes 304. It can be seen that the temperature gradient for the water 51 which has been pumped into the tubes 304 at inlet 305 is such that the temperature of the water within the second series of tubes 306 is higher then that in the first series of tubes at 304.

Continuing to refer to FIGS. 1A and 10 and FIG. 4, the water 51, which has now been turned to steam 58 by the action of the energy separation and recovery system 20, travels through the leading tube section 29 of the heat exchanger 30 into the trailing tube section 27 of the super heater 26 via connecting tube 307. Depending on the particular application and the temperature of the gas, a steam dryer assembly 310 may be advantageously interposed between the leading tube section 29 and the trailing tube section 27. The steam dryer assembly 310 constitutes a drying stage where, in the event that the steam from the heat exchanger 30 is wet, it may be appropriately dried and made ready for super heating.

Continuing to refer to FIGS. 1A, 2, 3, 4 and FIG. 11, the dry steam enters into the super heater 26 of the separation and recovery system 20, such that the temperature of the gas 18 at the trailing tube section 27 of the super heater 26 is a lower temperature than at the leading tube section 25 of the super heater 26. Accordingly, the steam 58 encounters increasingly hotter gases 18 as it travels from the trailing tube section 27 to the leading tube section 25 of the super heater 26. It can be appreciated that the temperature gradient for the steam 58 as it enters the super heater 26 is such that the steam 58 at the superheated steam exit port 308 is at substantially higher temperature than the steam at the entrance port 307 of the super heater 26.

During the travel of the steam 58 from the trailing tube section 27 to the leading tube section 25 of the super heater 26, the steam 58 becomes superheated steam 59. The superheated steam 59 is directed via a superheated steam exit port 308 to a steam engine 42. In general, the reciprocating steam engine 42 produces rectilinear motion in a piston by the supply of high-pressure, high temperature steam to a cylinder. In the instant invention, superheated steam 59 is employed to drive the cylinder (not shown). In most reciprocating piston engines the steam reverses its direction of flow at each stroke (counter flow), entering and exhausting from the cylinder by the same port. In the steam engine 42 illustratively employed in connection with the instant invention, the superheated steam 59 enters from an entry port 44 and exits from an exit port 45 in proximity to the entry port 44 and both located on the head section 100 of the steam engine 42, in order to complete the engine cycle, which occupies one rotation of the crank and two piston strokes. The cycle comprises several events—admission, expansion and exhaust. The steam engine 42 then changes the rectilinear motion of the pistons into rotary motion using a crank shaft (not shown) and rotates a driveshaft 47. A reciprocating steam engine 42 may also reverse the rectilinear motion direction of the piston using the inertial force of a flywheel installed at the crank shaft unit.

Because the superheated steam 59 loses heat as the energy is being taken from it, the superheated steam 59 sequentially becomes dry steam, wet steam and eventually water 51. In order to accommodate the decrease in temperature and the increase in moisture content the various steam components (also referred to as phases) can be drawn off at various points from the steam engine 42. By way of example reference is again made to FIG. 1A which shows the transfer of the various steam components in various phases. Dry steam 70 is collected from the piston blowby 71 and is conducted via tubing 72 to a tank 84. Wet steam 73 is collected from the oil sump 74 and conducted via tubing 75 to the tank 84. Additional wet steam 76 and water 51 are collected from the reserve oil reservoir 77 and conducted via tubing 78 to the tank 84. The steam 70, 73 and 76, after being conducted to tank 84, is conducted via ducting 79 to the water tank 52 where it is employed to recharge the energy separation and recovery system 20.

The superheated steam 59 exits from the exit port 45 as depleted steam 130 through a discharge pipe 48 which is connected to and passes through the reserve oil reservoir 77. The depleted steam 130 still contains sufficient energy to be employed to heat the oil within the reserve oil reservoir 77 to maintain it at a predetermined temperature. The depleted steam 130 continues through discharge pipe 48 to a condenser 80 where it is cooled by a fan assembly 82 and the resultant water 51 is transferred through piping 49 and returned to the water tank 52. As a part of the recapture mechanism, water from the several steam draw points is captured in tank 84 and is re-circulated to the water tank 52.

Referring to FIGS. 2A, 2B and 2C there is shown various illustrative configurations of the energy separation and recovery system 20 in combination with an illustrative energy source 10. The energy separation and recovery system 20 is first shown in FIG. 2A with a gating assembly 110 disposed in line with the exhaust duct 21 and having a pair of hinged diverter (not shown) disposed within the upper and lower sections of the gating assembly 110. The gating assembly 110 is designed to permit the gas 18 to either be diverted into the energy separation and recovery system 20, or to be exhausted to the atmosphere in the event that the energy separation and recovery system 20 is being serviced. This permits the energy source 10 to remain in continuous operation. The exhaust gas 18 is ultimately passed through a muffler 18A in order to reduce the noise which would otherwise be generated by the exhaust gas 18.

FIG. 2B illustrates the energy separation and recovery system 20 in combination with an illustrative energy source 10 where the system 20 is operatively connected to the energy source 10 for continuous operation. FIG. 2C illustrates the energy separation and recovery system 20 in combination with an illustrative energy source 10 where the system 20 is operatively connected to the energy source 10 to permit the substantially continuous use of the system 20. In such a configuration, the energy separation and recovery system 20 may be advantageously used to provide sufficient noise abatement and thereby eliminate the use of a muffler.

Referring again to FIG. 1A there is shown an expanded and detailed view of certain operative portions of the separation and recovery system 20. The steam engine 42 is, in the preferred embodiment a Voith steam expander. The steam engine 42 is drivingly associated with a generator 90. The steam engine 42, which is powered by the superheated steam derived by the separation and recovery system 20, rotationally engages the generator 90. In the preferred embodiment the generator 90 is an alternating current generator. The alternating current is passed through to an inverter 92 which then permits the electricity to be transferred to an energy supplier 19 such as the national grid.

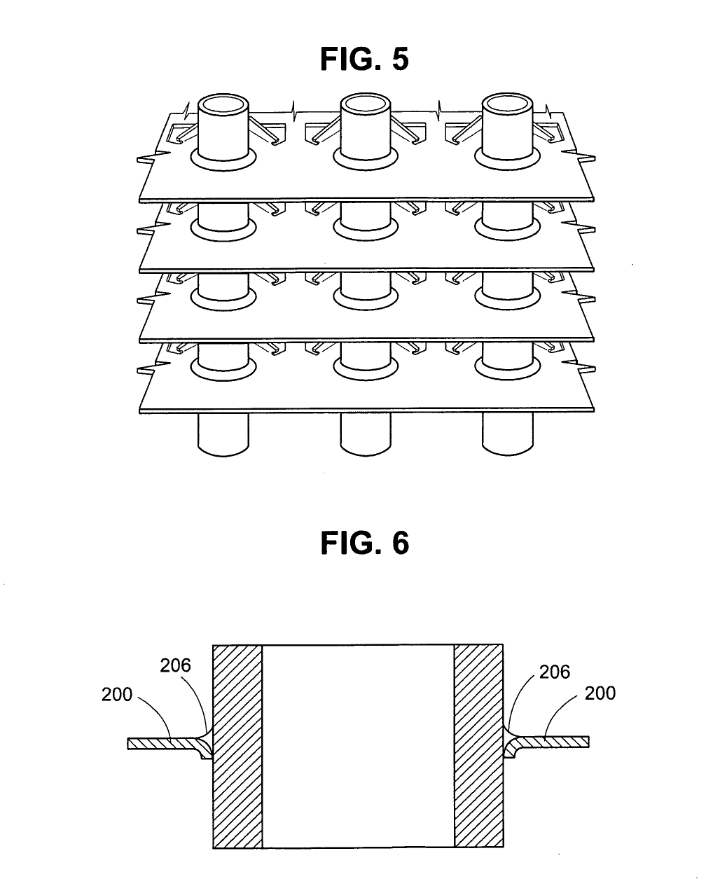

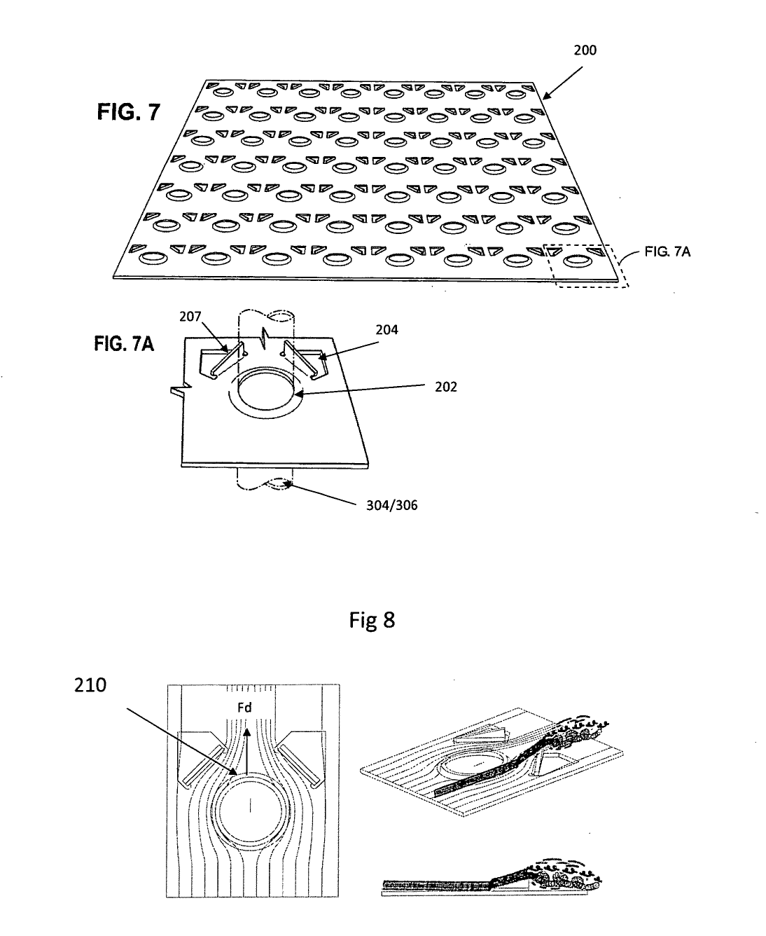

Referring again to FIG. 4 in conjunction with FIGS. 5, 7 and 7A, there is shown a preferred embodiment of a vortex fin array 200 which is disposed perpendicular to the heat exchange tubing 304 and 306. The vortex fin array 200 is comprised of a series of circular apertures 202 through which the heat exchange tubing 304 and 306 extends. The heat exchange tubing 304 and 306 is affixed to the vortex fin array 200. In a preferred embodiment of the invention, the vortex fin array 200 and the heat exchange tubing 304 and 306 are braised to further increase the heat transfer between the waste heat exhaust gas 18 and the water 51 traveling through the respective heat exchange tubing 304 and 306.

Referring to FIG. 7A there is shown a view of one portion of a representative section of heat exchange tubing 304 or 306 and a pair of associated vortex fins 204. The heat exchange tubing 304 or 306 extends in a substantially perpendicular orientation relative to the fin array 200. The vortex fins 204 are in an orientation substantially parallel the longitudinal axis of the heat exchange tubes 304 or 306 and at a 45° orientation relative to the flow direction of the waste gas 18. Referring to FIG. 6, there is shown a sectional view of the interface between tubes 304 or 306 and the fin array 200. A braze 206 is circumferentially disposed around the entire tube 304 or 306 to bond the respective tube to the vortex fin array 200.

The fins 204 are elevated from the surface of the vortex fin array 200 in a direction substantially parallel to the longitudinal axis of the respective heat exchange tubes 304 and 306 and are advantageously disposed on the rear section 210 of each heat exchange tube 304 and 306, where the rear section 210 is defined as that portion of the heat exchange tube 304 and 306 which is down stream from the direction of flow of the waste heat exhaust gases 18. In a preferred embodiment of the invention twin fins 204 are punched into the vortex fin array 200 such that each fin 204 is substantially perpendicular to the vortex fin array 200. Each fin 204 is disposed at an angle which is approximately 45° from the direction of flow of the exhaust heat gases 18. Each fin 204 extends upwardly and has an upper edge 206 which is substantially similar in length to the length of the fin 204 where each of the fins 204 is affixed to the vortex fin array plate 200. The purpose of the fins 204 is to disturb the airflow around the rear section 210 of each of the heat exchanger tubes 304 and 306 for increased heat transfer.

Referring to FIG. 8 there is shown a diagrammatic representation of the flow of waste heat exhaust gases 18 around the heat exchanger pipes 304 and 306. With the introduction of the fins 204, the flow is disturbed on the rear section 210 represented by arrow Fd such that the flow is diverted approximately 45° causing the waste heat exhaust gas 18 to curl backward and further contact the heat exchanger pipes 304 and one 306.

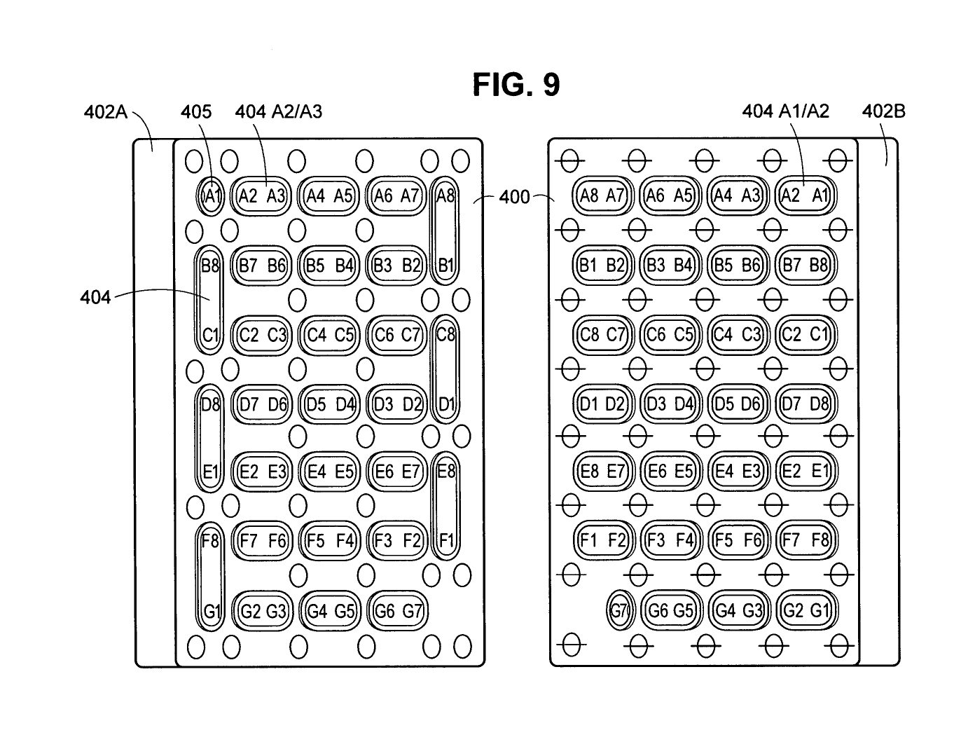

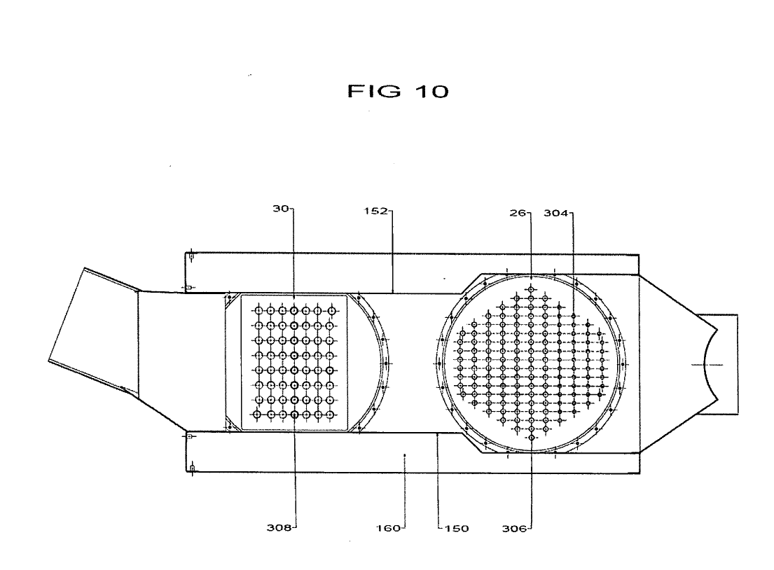

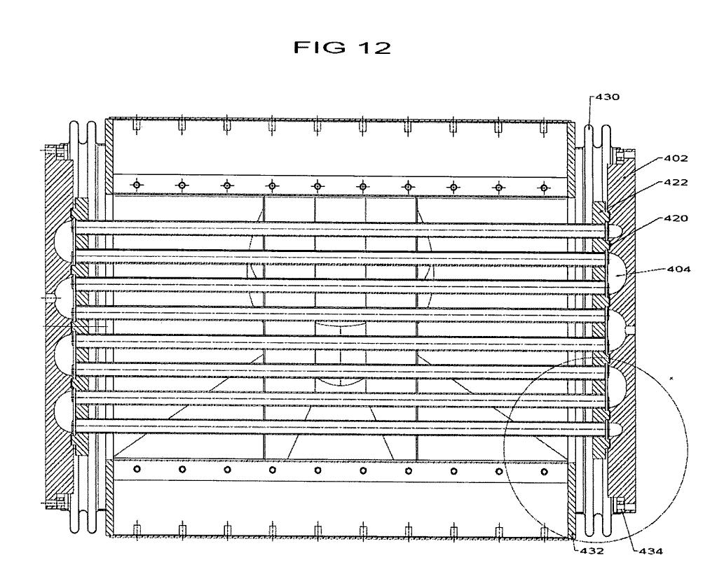

Referring to FIG. 9 there is shown an interior view of a pair of heads 400 which comprises two corresponding heads 402A and 402B for linking adjacent piping structures within the heat exchanger 30 and within the super heater 26 to form a continuous path through each and therefore through both, in accordance with one embodiment of the present invention. Each of the corresponding heads 402A and 402B is comprised of a series of semicircular virtual pipe bends 404, each of which straddles sequential sections of straight heat exchanger tubes 304 and 306 or super heater tubes 308, to provide the travel channel for the fluid within each tube and the travel path for the fluid through all of the tubes 304, 306 and 308. As is best seen in FIG. 9, the inlet 405, in the upper right most corner of head 402A has inserted therein representative tube 304-A1. The insertion and expansion of the tubes 304, 306 and 308 into each head 402 will be discussed hereinafter. Representative tube 304-A1 extends through the heat exchanger 30 and the other end is inserted into the upper left most corner of head 402B at virtual pipe bend 404-A1/A2. A second representative tube 304-A2 is inserted at the lower section of virtual pipe bend 404-A1/A2 and extends into the upper section of virtual pipe bend 404-A2/A3 located on head 402A. As can be best appreciated by referring to FIG. 9 and FIG. 12, the tubes extend between the two heads 402A and 402B in a substantially parallel configuration to permit the fluid to flow from one to the other with minimal obstruction.

The configuration shown and describe above, when viewed with reference to FIG. 10, illustrates the internal pumping system which permits the fluid to travel though the piping structure in the heat exchanger 30 and the super heater 26 without the necessity of any additional mechanical pumping mechanism deployed within either the heat exchanger 30 or the super heater 26. FIG. 10 illustrates the parallel piping structure of the heat exchanger 30 and the super heater 26 in which the heads 402 has been removed to permit the viewing of the tubes 304, 306 and 308. In the illustrative embodiment shown in FIG. 10, the super heater 30 is shown as a square core structure and the heat exchanger 26 is shown as a circular core structure. It will be appreciated that the core configuration can be adapted to optimize the energy separation and recovery which is accomplished by the system and will generally be a function of, among other things, the input gas temperature and the desired output super heated steam which is being delivered for end use. In FIG. 10, it can be seen that the super heater 30 is situated on a raised bed 150 within the system cabinet 160. There is also a corresponding roof structure 152 over the super heater 30 such that between the raised bed 150 and the roof structure 152, the gas 18 is required to pass around the tubes 308 of the super heater 30, rather than being able to circumvent the tubes 308. As the result of the circular configuration of the heat exchanger 26 which is shown in FIG. 10, the upper and lower circumferential portions of the heat exchanger 26 are in close proximity to the upper and lower portions of the system cabinet 160 in order to cause the gas 18 to flow over the tubes 304 and 306 of the heat exchanger 26.

The virtual pipe bends 404 provide numerous advantages over traditional pipe bends which would otherwise be used to connect sequential sections of straight pipe 304, 306 and 308 as is illustratively shown in FIG. 11 and FIG. 12. A traditional pipe bend radius on a ¾″ tube is approximately 1.75 inches. When bending a tube or pipe, the material is generally thinner on the out side surface and crumpled on the inside edge thereby creating weaknesses. Additionally once fluid is forced to change direction rapidly, as would occur when it is forced around a tight bend, water hammer can occur and over time eat into the tube bend and causing a failure. By providing a virtual pipe bend 404, thicker material can be employed to provide greater strength and less likelihood of failure at the pipe bend juncture. Another advantage of employing virtual pipe bends 404 on a separation and recovery system 20 is that each head 402 can be removed in order to permit the full disassembly of the heat exchanger 30 and the super heater 26 and thereby access the straight tube sections 304 and 306 or 308, respectively to permit cleaning or repair of those sections as well as the virtual pipe bends 404. Another advantage is that the internal straight sections 304, 306 and 308 can be changed to give greater heat exchange 30 volume or super heater 26 area as is required in any particular application.

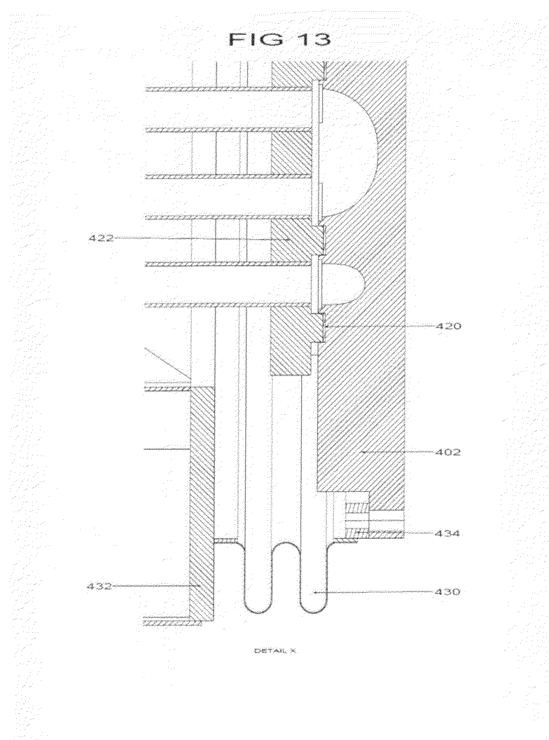

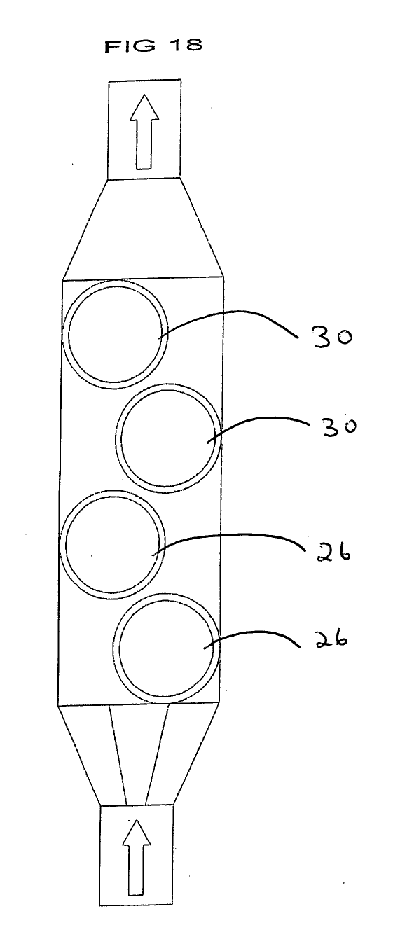

Referring to FIGS. 10, 11, 12, 13 and 17, there is shown a preferred embodiment of the heads 402 and a gasket 420 arrangement in order to provide a fluid return route through the virtual pipe bends 404 in the heat exchanger 30 and super heater 26 elements of the separation and recovery system 20. A gasket 420 is interposed between the head 402 of the heat exchanger 30 core and the tube plate 422 which carries the tubes 304, 306 or 308. As is shown illustratively in FIG. 17, two parallel and sequential heat exchanger tubes 304 or 306 (or super heater tubes 308) are juxtaposed to each virtual pipe bend 404, which provides the fluid return conduit between sequential sections of straight pipe 304, 306 or 308. Viewing the sequential piping designations shown in FIG. 9 and the cross-section shown in FIG. 12, is can be appreciated that the flow path of the fluid medium used to separate and recover the energy from the gas 18 is in substantially continuous contact with the energy carrying gas 18. At the same time the tubes 304, 306 and 308 are situated behind one another to minimize the back pressure from the heat exchanger 26 and the super heater 30.

It is to be appreciated that although water has been used as an example above, the system may also be employed with other liquids/fluids/plasmas which are able to be vaporized and transmit energy thereby.

As is best illustrated in FIGS. 12, 14 and 17, each head 402 is affixed to the tube plate 422 with a gasket 420 interposed there between and two parallel and sequential heat exchanger tubes 304 or 306 are secured to the tube plates 422 such that each virtual pipe bend 404 provides the fluid return conduit between sequential sections of straight pipe 304 and 306. A bellows 430 is welded to the external casing 432 and extends outwardly therefrom to provide a flexible segment to accommodate lateral displacement due to heat expansion of the pipes 304 or 306 which are connected to the two tube plates 422. The exterior edge of the bellows 430 has affixed thereto a flange 434 to which the head 402 is affixed. Because the heating differential between the input side of the separation and recovery system 20 and the output side may vary by over 300° C., the expansion of the tubes 304, 306 and 308 and related assemblies is not equal throughout the flow area of the gas 18. In the area closest to the input of the gas 18 where the temperature is approximately 1000° F., the tubes 308 will tend to expand more along the longitudinal axis at the entrance area of the super heater 26. Similarly the leading area of the heat exchanger 30 will be at a higher temperature than the trailing portion of the heat exchanger 30. In order to accommodate the differential expansion of the tubes 304, 306 and 308, the bellows 430 permits the heads 402 to accommodate the differential expansion by lateral movements at either end to accommodate expansion along the longitudinal axis of the tubes 304, 306 and 308.

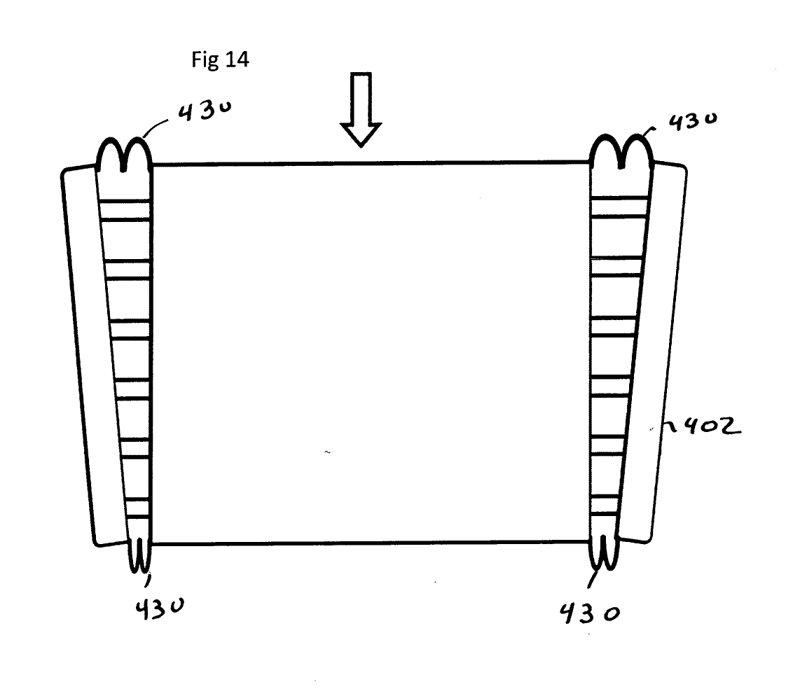

Referring to FIG. 14 there is shown illustratively the operation of the bellows system 430 as the result of the application of energy carrying gas 18 from a heat source through the super heater 26 and the heat exchanger 30. As can be appreciated, the greater the heat the more the individual tubes are likely to expand along their respective longitudinal axis. The bellows system 430 is designed to allow for that uneven expansion without causing a reduction in the efficiency of the unit or leaks of the superheated steam. At the same time by permitting the expansion it maintains the tubes 304, 306 and 308 in parallel alignment thereby permitting the steam to enter and exit the virtual pipe bends 404 of the heads 402 with minimal distortion or backflow problems.

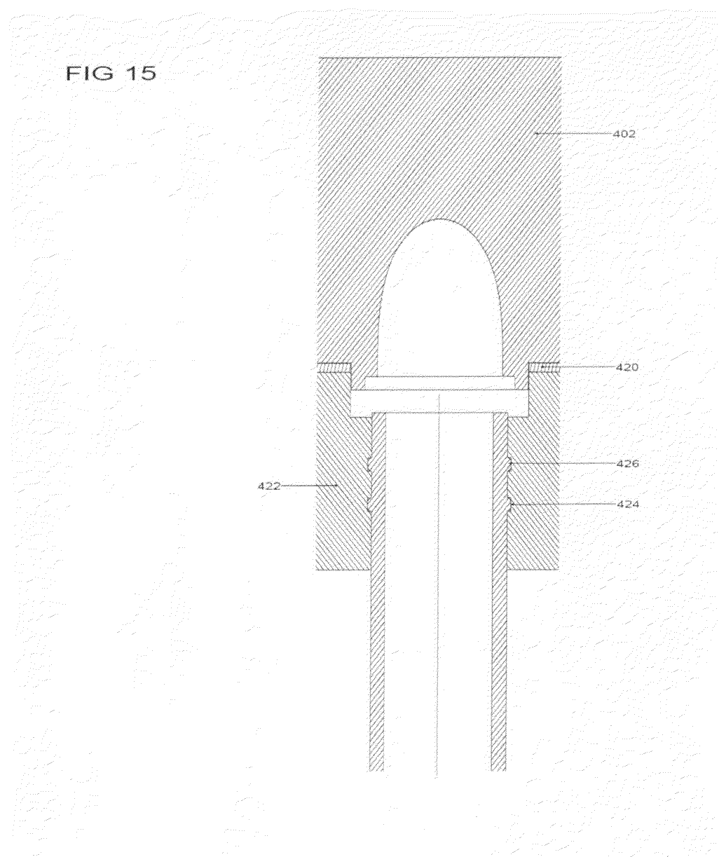

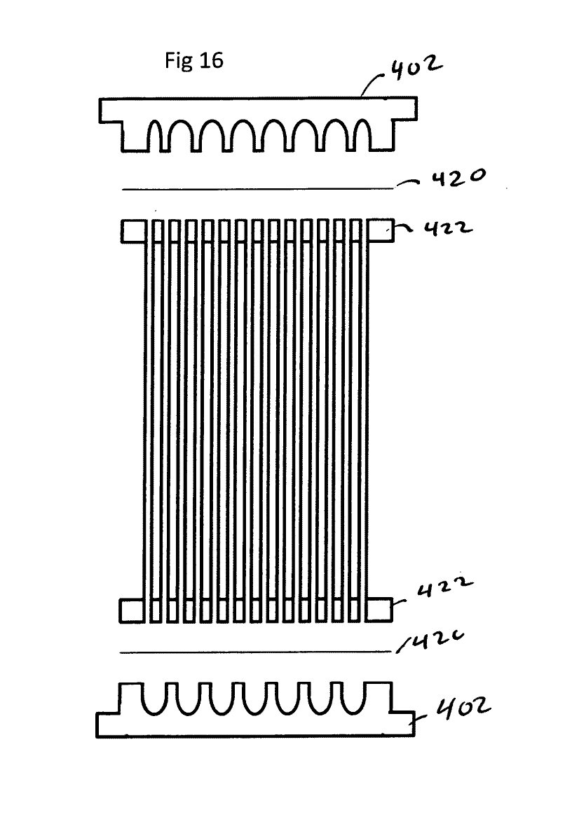

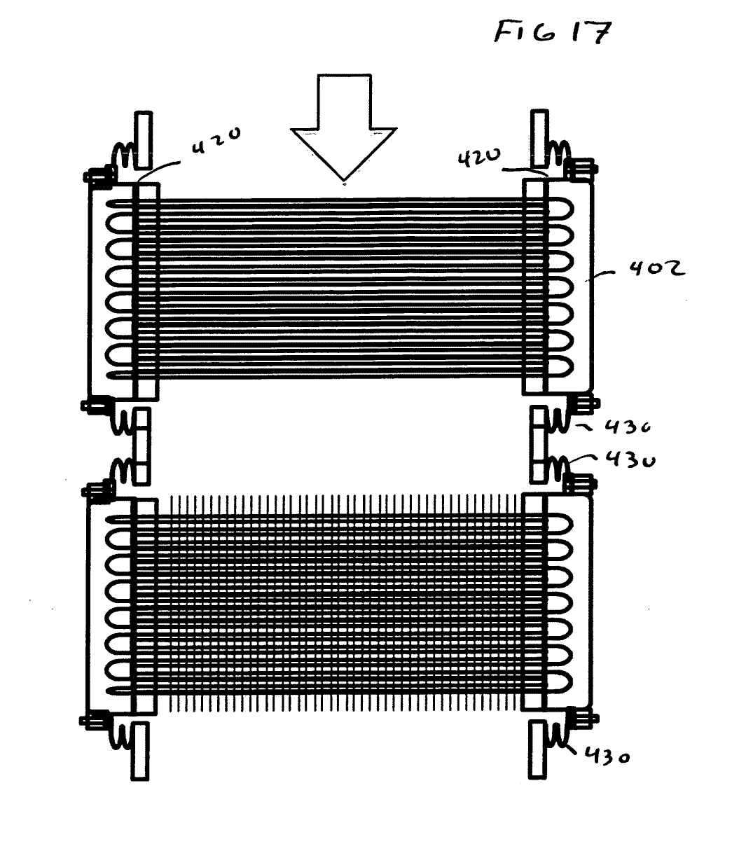

Referring to FIG. 15 there is shown a graphic representation of the head 402 interlocked to the tube plate 422 with the gasket 420 interposed between the head 402 and the tube plate 422. As is illustrated in FIG. 15, each tube 304, 306 or 308 sits approximately 0.5 mm proud of the exterior most edge of the tube plate 422 in the area of the virtual pipe bend 404. A series of tube role grooves 424 are circumferentially disposed within each hole in the tube plate 422. Each tube 304, 306 and 308 is pressure fitted into the respective hole such that the metal is compressed in the area where the tube and the tube plate meet. The resultant radial pressure results in the formation of tube role expansions 426 in the location of each tube which is adjacent to a corresponding tube role groove 424. Thus, as can be seen graphically in FIG. 15, a mating and sealing arrangement is thereby obtained to hold each tube 304, 306 or 308 to the head without the need for welding.

Referring to FIG. 17 there are shown in diagrammatic representation form the core which houses the tubes 304 and 306 or 308 of either the heat exchanger 30 or the super heater 26 to the heads 404 with illustrative bellows 430 at either end of the heads 404. It is also illustratively depicted that the bellows 430 are secured to the outer portion 432 of the housing so as to provide a secure seal and prevent any escape of gas 18, while provide the angular movement necessary to accommodate the differential expansion of the tubes 304, 306 and 308. This can be appreciated to be a representation which shows the separation and recovery system 20 in a non-heated mode where substantially equal temperature is maintained throughout. In such a state the tubes 304, 306 and 308 would remain approximately of equal length and the bellows 430 a would not be required to perform any differential movement of the heads 404. In contradistinction, by referring to FIG. 14 there are shown the variable expansion which occurs during operation of the separation and recovery system 20 and the manner in which the bellows 430 is differentially moved in accordance with the relative expansion along the lateral axis of each of the tubes 304, 306 and 308.

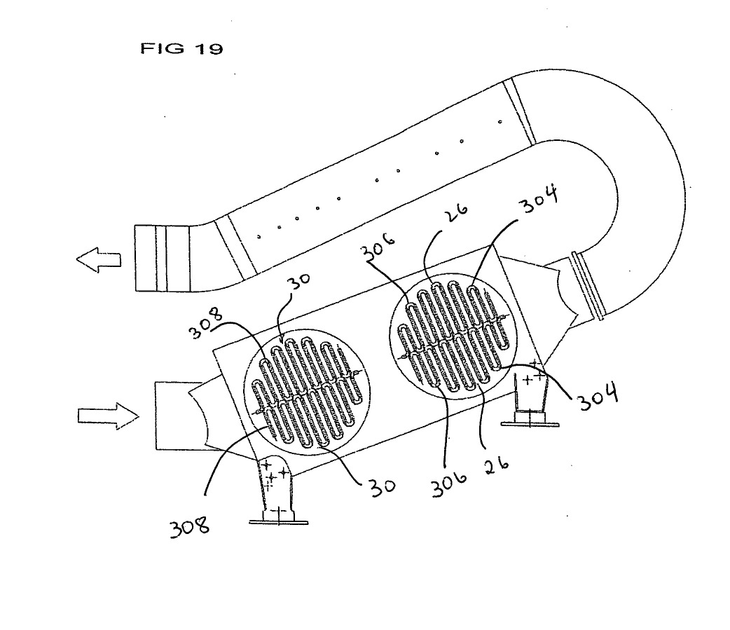

Referring to FIG. 18, there is shown an illustrative example of a multi-core energy separation and recovery system 20, in accordance with another embodiment of the invention. The housing contains a series of super heaters 30 which contact the gas 18 before the heat exchangers 26 contact the gas 18. The number of heat exchangers 26 and super heaters 30 may be varied depending upon the particular application, the input temperatures and the desired output temperatures and use to which the superheated steam is to be put. Similarly, the tubing system may run from one or more heat exchangers into a single super heater or from a single heat exchanger into one or more super heaters. As is shown in FIG. 19, it is a further object of this invention to provide the capability of dividing the core structure of either the heat exchanger, super heater or both so that the energy which has been separated and recovered can be used to run separate steam engines on independent or coordinated steam circuits or be use for several applications simultaneously.

Test Data from a System Test

| | | | | Steam Expander | | | |
|---|---|---|---|---|---|---|---|
| | | | | | | | Steam |
| Waste Heat Engine | | | | | | Steam | inlet |
| Power | | Torq | Exhaust | KW | | Inlet | Pressure |
| KW | RPM | Nm | Temp C. | Elec | RPM | Temp C. | BAR |
| 257.5 | 1350 | 1860 | 621 | 17.11 | 1295 | 364 | 37.6 |

| | Compact Heat Exchanger | |
|---|---|---|
| Water In | Temp Diff | Outlet |
| l/min | in/out | Temp C. |
| 4.5 | 250.2 | 370.8 |

Test Data from a System with Differing Input Power and Resultant Output from Steam Engine

| PWR KW | KW Out |
|---|---|
| 151.52 | 8 |
| 189.39 | 10 |
| 227.27 | 12 |
| 265.15 | 14.5 |
| 303.03 | 18 |

For the purposes of promoting an understanding of the principles of the invention, reference has been made to the embodiments illustrated in the drawings and specific language used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates.

Any experimental (including simulation) results are exemplary only and are not intended to restrict any inventive aspects of the present application. Any theory, mechanism of operation, proof, or finding stated herein is meant to further enhance understanding of the present invention and is not intended to make the present invention in any way dependent upon such theory, mechanism of operation, proof, or finding. It should be understood that while the use of the word preferable, preferably or preferred in the description above indicates that the feature so described may be more desirable, it nonetheless may not be necessary and embodiments lacking the same may be contemplated as within the scope of the invention, that scope being defined by the claims that follow. In reading the claims it is intended that when words such as “a,” “an,” “at least one,” “at least a portion” are used there is no intention to limit the claim to only one item unless specifically stated to the contrary in the claim. Further, when the language “at least a portion” and/or “a portion” is used the item may include a portion and/or the entire item unless specifically stated to the contrary. While the invention has been illustrated and described in detail in the drawings and foregoing description, the same is to be considered as illustrative and not restrictive in character, it being understood that only the selected embodiments have been shown and described and that all changes, modifications and equivalents that come within the spirit of the invention as defined herein or by any claims that follow are desired to be protected.

Although the control systems have been described generally, aspects of the control algorithm and the interrelationship between the algorithm, the sensed parameters and the controlled elements are also a part of the invention. By way of example, valve designs and controls form important inventive concepts that have applicability in other separation and recovery and steam generation systems.

In addition, although a methane landfill incinerator may be employed as a source of gas to power the engine which is providing the gas 18, it is merely one example to describe the inventive concepts set forth herein. It is understood that a conventional incinerator or other source of high temperature waste heat may be employed, as well as a source of waste heat from burning of such material as natural gas, particularly flash gas at well head locations.

Although the description herein recites water as the fluid, that is not meant to limit the scope of this invention and is used for illustrative purposes only. Those skilled in the art may substitute other appropriate fluids, depending on circumstances and applications, consistent with the inventive concepts disclosed herein.

It will be appreciated also by those skilled in the art that changes could be made to the embodiments described above without departing from the broad inventive concepts thereof. It is understood, therefore, that this invention is not limited to the particular embodiments disclosed but it is intended to cover modifications within the spirit and scope of the present invention as defined by the appended claims.

We claim:

1. An energy separation and recovery system to recover thermal energy from a thermal waste energy source comprising a thermal energy transfer core for transferring the thermal energy from the waste energy source to a fluid, vaporizable energy capture medium, the energy capture medium being introduced into the separation and recovery system at a point furthermost from the entrance point of the thermal waste energy, said capture medium being conveyed through a series of interconnected tubes within the separation and recovery system to absorb incrementally the thermal waste energy, wherein the thermal energy transfer core comprises a first energy transfer array disposed towards the furthermost point from the entrance point of the thermal waste energy and a second energy transfer array disposed between the entrance point of the thermal waste energy and the first energy transfer array, the first and second energy transfer arrays being connected to permit continuous flow of the capture medium from the first to the second energy transfer arrays, said first energy transfer array separating sufficient waste energy to vaporize the capture medium and said second energy transfer array separating sufficient energy from the thermal waste energy to superheat the vaporized capture medium.

2. An energy separation and recovery system to recover thermal energy from a thermal waste energy source as claimed in claim 1 wherein the thermal waste energy source is derived from landfill gas harvesting.

3. An energy separation and recovery system to recover thermal energy from a thermal waste energy source as claimed in claim 1 wherein the thermal waste energy consists of a gas which flows in direction opposite to the capture medium.

4. An energy separation and recovery system to recover thermal energy from a thermal waste energy source as claimed in claim 1 wherein the first transfer array is comprised of a plurality of tubes parallel to one another.

5. An energy separation and recovery system to recover thermal energy from a thermal waste energy source as claimed in claim 4 wherein second transfer array is comprised of a plurality of tubes parallel to one another.

6. An energy separation and recovery system to recover thermal energy from a thermal waste energy source as claimed in claim 5 wherein the first and second transfer arrays each have the longitudinal axis of each tube disposed substantially perpendicular to the direction of flow of the thermal waste energy gas.

7. An energy separation and recovery system to recover thermal energy from a thermal waste energy source as claimed in claim 6 wherein the first and second transfer arrays are disposed so as to minimize the back pressure upon the thermal waste energy gas.

8. An energy separation and recovery system to recover thermal energy from a thermal waste energy source as claimed in claim 6 wherein successive tubes are connected by a virtual pipe bend assembly.

9. An energy separation and recovery system to recover thermal energy from a thermal waste energy source as claimed in claim 6 wherein a plurality of successive tubes are connected by means of a head comprise of at least one virtual pipe bend assembly.

10. An energy separation and recovery system to recover thermal energy from a thermal waste energy source as claimed in claim 6 wherein the plurality of tubes are rigidly affixed to a tube plate to maintain them in substantially parallel alignment.

11. An energy separation and recovery system to recover thermal energy from a thermal waste energy source as claimed in claim 10 wherein the heads are attached to the tube plates and the head and tube plate assembly is flexibly attached to the heat exchanger casing to permit differential expansion of the tubes without loss of energy captured by the fluid capture medium or loss of fluid.

12. An energy separation and recovery system to recover thermal energy from a thermal waste energy source as claimed in claim 10 wherein the head and tube assembly is flexibly attached by a bellows arrangement attached between the assembly and the heat exchange casing.

13. An energy separation and recovery system to recover thermal energy from a thermal waste energy source as claimed in claim 10 wherein the heads and tube plates may be comprised of materials having different rates of expansion to further seal upon application of heat transfer from the energy capture fluid.

14. An energy separation and recovery system to recover thermal energy from a thermal waste energy source as claimed in claim 4 wherein the first transfer array having affixed to at least one tube thereof a vortex fin disposed proximate to the rearmost section of the tube to promote turbulent flow of the thermal waste energy gas.

15. An energy separation and recovery system to recover thermal energy from a thermal waste energy source as claimed in claim 14 wherein the turbulent flow thereby permits substantially uniform heat transfer across the first array.

16. An energy separation and recovery system to recover thermal energy from a thermal waste energy source as claimed in claim 14 wherein the turbulent flow increases the heat transfer from the gas to the rear of the tube.

17. An energy separation and recovery system to recover thermal energy from a thermal waste energy source as claimed in claim 4 wherein the first transfer array having affixed to a plurality of tubes a fin array by thermal brazing or other technique to maximize heat transfer there between.

18. An energy separation and recovery system to recover thermal energy from a thermal waste energy source as claimed in claim 5 wherein a dryer is interposed between the first and second transfer arrays.

19. An energy separation and recovery system to recover thermal energy from a thermal waste energy source comprising a thermal energy transfer core for transferring the thermal energy from the waste energy source to a fluid, vaporizable energy capture medium, the energy capture medium being introduced into the thermal energy transfer core of the separation and recovery system at a point furthermost from the entrance point of the thermal waste energy, said capture medium being conveyed through multiple series of tubes within the separation and recovery system to absorb incrementally the thermal waste energy, wherein the thermal energy transfer core comprises at least two first energy transfer arrays disposed towards the furthermost point from the entrance point of the thermal waste energy and at least two second energy transfer arrays disposed between the entrance point of the thermal waste energy and the at least two first energy transfer arrays, one of the first and one of the second energy transfer arrays being connected to form a first recovery unit to permit continuous flow of the capture medium from said one first energy array to said one second energy transfer array of the first recovery unit, and the other first energy transfer array and the other second energy array arrays being connected to form a second recovery unit to permit continuous flow of the capture medium from said other first energy array to said other second energy transfer array of the second recovery unit, each first energy transfer array separating sufficient waste energy to vaporize the capture medium flowing there through and said second energy transfer array separating sufficient energy from the thermal waste energy to superheat the vaporized capture medium flowing there through.

20. An energy separation and recovery system to recover thermal energy from a thermal waste energy source as claimed in claim 19 wherein the thermal waste energy source is derived from landfill gas harvesting.

21. An energy separation and recovery system to recover thermal energy from a thermal waste energy source as claimed in claim 19 wherein the thermal waste energy consists of a gas which flows in direction opposite to the capture medium.

22. An energy separation and recovery system to recover thermal energy from a thermal waste energy source as claimed in claim 19 wherein each of the first transfer arrays is comprised of a plurality of tubes parallel to one another.

23. An energy separation and recovery system to recover thermal energy from a thermal waste energy source as claimed in claim 22 wherein each of the second transfer arrays is comprised of a plurality of tubes parallel to one another.

24. An energy separation and recovery system to recover thermal energy from a thermal waste energy source as claimed in claim 23 wherein each of the first and second transfer arrays each have the longitudinal axis of each tube disposed substantially perpendicular to the direction of flow of the thermal waste energy gas.

25. An energy separation and recovery system to recover thermal energy from a thermal waste energy source as claimed in claim 24 wherein each of the first and second transfer arrays are disposed so as to minimize the back pressure upon the thermal waste energy gas.

26. An energy separation and recovery system to recover thermal energy from a thermal waste energy source as claimed in claim 24 wherein successive tubes within each array are connected by a virtual pipe bend assembly.

27. An energy separation and recovery system to recover thermal energy from a thermal waste energy source as claimed in claim 24 wherein a plurality of successive tubes for each array are connected by means of a head comprise of at least one virtual pipe bend assembly.

28. An energy separation and recovery system to recover thermal energy from a thermal waste energy source as claimed in claim 24 wherein the plurality of tubes are rigidly affixed to a tube plate to maintain them in substantially parallel alignment.

29. An energy separation and recovery system to recover thermal energy from a thermal waste energy source as claimed in claim 28 wherein the heads are attached to the tube plates and the head and tube plate assembly is flexibly attached to the heat exchanger casing to permit differential expansion of the tubes without loss of energy captured by the fluid capture medium or loss of fluid.

30. An energy separation and recovery system to recover thermal energy from a thermal waste energy source as claimed in claim 28 wherein the head and tube assembly is flexibly attached by a bellows arrangement attached between the assembly and the heat exchange casing.

31. An energy separation and recovery system to recover thermal energy from a thermal waste energy source as claimed in claim 28 wherein the heads and tube plates may be comprised of materials having different rates of expansion to further seal upon application of heat transfer from the energy capture fluid.

32. An energy separation and recovery system to recover thermal energy from a thermal waste energy source as claimed in claim 22 wherein each first transfer array has affixed to at least one tube thereof a vortex fin disposed proximate to the rearmost section of the tube to promote turbulent flow of the thermal waste energy gas.

33. An energy separation and recovery system to recover thermal energy from a thermal waste energy source as claimed in claim 32 wherein the turbulent flow thereby permits substantially uniform heat transfer across each first array.

34. An energy separation and recovery system to recover thermal energy from a thermal waste energy source as claimed in claim 32 wherein the turbulent flow increases the heat transfer from the gas to the rear of the tube.

35. An energy separation and recovery system to recover thermal energy from a thermal waste energy source as claimed in claim 22 wherein each of the first transfer arrays has affixed to a plurality of tubes a fin array by thermal brazing or other technique to maximize heat transfer there between.

36. An energy separation and recovery system to recover thermal energy from a thermal waste energy source as claimed in claim 23 wherein a dryer is interposed between at least one of the first and second transfer arrays.
